(19) United States
(12) Patent Application Publication
(10) Pub. No.: US 2023/0406674 A1
(43) Pub. Date: Dec. 21, 2023

(54) ELEVATOR SYSTEM IMPLEMENTING A MULTI-LINEAR MULTI-PHASE INDUCTION MACHINE INCLUDING A PLURALITY OF STATORS CONTROLLED IN PARALLEL

(71) Applicant: Otis Elevator Company, Farmington, CT (US)

(72) Inventor: Dan Vasile, Charlotte, NC (US)

(21) Appl. No.: 17/842,002

(22) Filed: Jun. 16, 2022

(51) Int. Cl. B66B 11/04; H02K 41/025

(52) U.S. Cl. CPC B66B 11/0407; H02K 41/025

(57) ABSTRACT

A multi-phase linear induction machine includes at least one armature which can be disposed in an elevator hoistway and is configured to electrically conduct electromagnetic energy, and a plurality of stators which can be coupled to an elevator car that is configured to travel through the hoistway. Each of the stators are configured to conduct electrical current therethrough and generate an electromagnetic field in response to the current. The electromagnetic field induces eddy currents that flow through the at least armature to generate a magnetic force to move the elevator car through the hoistway.

### BACKGROUND

The present disclosure generally relates to elevator systems, and in particular, to self-propelled elevator systems.

Traditional elevator systems implement tensions members such as ropes and/or cables, for example, to move one or more elevator cars in a hoistway. More recently, however, self-propelled elevator systems, also referred to as “ropeless” elevator systems, are being utilized in various applications (e.g., high rise buildings) where it is undesirable to implement traditional tension members to move the elevator car.

### BRIEF SUMMARY

In accordance with some embodiments, a multi-phase linear induction machine included in an elevator system is provided. The multi-phase induction machine comprises at least one armature that can electrically interact with a plurality of stators. The at least one armature can be disposed in a hoistway and is configured to electrically conduct electromagnetic energy. The plurality of stators can be coupled to an elevator car that is configured to travel through the hoistway. Each of the stators are configured to conduct electrical current therethrough and to generate an electromagnetic field in response to the current. The electromagnetic field induces eddy currents that flow through the at least armature to generate a magnetic force which moves the elevator car through the hoistway.

In addition to one or more of the features described above, or as an alternative, further embodiments may include, a first armature disposed in the hoistway and a second armature disposed in the hoistway opposite the first armature.

In addition to one or more of the features described above, or as an alternative, further embodiments may include a feature, wherein the first and second armatures include an electrically conductive material capable of conducting the induced electric eddy currents therethrough.

In addition to one or more of the features described above, or as an alternative, further embodiments may include a feature, wherein the first and second armatures extend vertically along a length of the hoistway.

In addition to one or more of the features described above, or as an alternative, further embodiments may include a feature, wherein plurality of stators includes a first set of stators coupled to a first side of the elevator car and adjacent the first armature, and a second set of stators coupled to a second side of the elevator car opposite the first side of the elevator car and adjacent the second armature.

In addition to one or more of the features described above, or as an alternative, further embodiments may include a feature, wherein the first set of stators and the second set of stators are electrically connected to power electronics that are configured to deliver the electrical current to the first and second set of stators.

In addition to one or more of the features described above, or as an alternative, further embodiments may include a feature, wherein the power electronics receive battery power from a rechargeable battery, and covert the battery power into the electrical current that is delivered to the first and second set of stators.

In addition to one or more of the features described above, or as an alternative, further embodiments may include a feature, wherein a controller is configured to control the power electronics and selectively control the direction of the current flow through the first and second armatures.

In addition to one or more of the features described above, or as an alternative, further embodiments may include a feature, wherein current flowing through the first and second set of stators in a first direction generates an electromagnetic filed having a flux that travels in a first direction, and current flowing through the first and second set of stators in a second direction generates an electromagnetic field having a flux that travels in a second direction opposite the first direction.

In addition to one or more of the features described above, or as an alternative, further embodiments may include a feature, wherein the flux traveling in the first direction produces a first magnetic force that moves the elevator car through the hoistway in a first vertical direction, and wherein the flux traveling in the second direction produces a second magnetic force that moves the elevator car through the hoistway in a second vertical direction opposite the first vertical direction.

In addition to one or more of the features described above, or as an alternative, further embodiments may include a feature, wherein the controller invokes a recharge mode and in response to invoking the recharge mode moves the elevator car to a docking station included in the hoistway to recharge the battery.

In addition to one or more of the features described above, or as an alternative, further embodiments may include a feature, wherein the docking station includes a battery charger, and wherein moving the elevator car to the docking station establishes electrical transfer between the rechargeable battery and the battery charger to recharge the battery.

The multi-phase induction linear induction machine of claim 1, wherein the at least one armature and the plurality of stators establish a three-phase machine.

In addition to one or more of the features described above, or as an alternative, further embodiments may include a feature, wherein two or more stators are coupled adjacent to the elevator car.

In addition to one or more of the features described above, or as an alternative, further embodiments may include a feature, wherein the two or more stators are configured to maintain a center car axis of the elevator car in line with a center hoistway axis of the hoistway.

In accordance with some embodiments, a method of controlling a multi-phase linear induction machine included in an elevator system is provided. The method comprises disposing at least one armature disposed in a hoistway to electrically conduct electromagnetic energy, and coupling a plurality of stators coupled to an elevator car configured to travel through the hoistway. The method further comprises conducting electrical current through each of the stators to generate an electromagnetic field, and inducing a flow of eddy currents through the at least armature in response to the electromagnetic field to generate a magnetic force that moves the elevator car through the hoistway.

In addition to one or more of the features described above, or as an alternative, further embodiments may include a feature, wherein the at least one armature includes a first armature disposed in the hoistway and a second armature disposed in the hoistway opposite the first armature.

In addition to one or more of the features described above, or as an alternative, further embodiments may include a feature, wherein the first and second armatures include an electrically conductive material capable of conducting the eddy currents therethrough.

In addition to one or more of the features described above, or as an alternative, further embodiments may include a feature, wherein the first and second armatures extend vertically along a length of the hoistway.

In addition to one or more of the features described above, or as an alternative, further embodiments may include a feature, wherein the plurality of stators includes a first set of stators coupled to a first side of the elevator car and adjacent the first armature, and a second set of stators coupled to a second side of the elevator car opposite the first side of the elevator car and adjacent the second armature.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates a self-propelled elevator system capable of implementing a multi-phrase linear induction machine according to a non-limiting embodiment of the present disclosure;

FIG. 2 illustrates a multi-phrase linear induction machine for moving an elevator car in a self-propelled elevator system according to a non-limiting embodiment of the present disclosure;

FIG. 3 illustrates a stator included in a three-phrase linear induction machine configured to move an elevator car in a self-propelled elevator system according to a non-limiting embodiment of the present disclosure;

FIG. 4A illustrates a magnetic field interaction between an armature and a plurality of stators included in a three-phrase induction machine to induce movement of the stator in a first direction according to a non-limiting embodiment of the present disclosure;

FIG. 4B illustrates a magnetic field interaction between an armature a plurality of stators included in a three-phrase induction machine to induce movement of the stator in a second direction according to a non-limiting embodiment of the present disclosure;

FIG. 5 illustrates an elevator system implementing a three-phrase induction machine that includes one or more stators and an elevator car installed with rechargeable battery according to a non-limiting embodiment of the disclosure; and

FIG. 6 illustrates the elevator car of FIG. 5 stowed in a lower docking station to charge the rechargeable battery according to a non-limiting embodiment of the disclosure.

### DETAILED DESCRIPTION

At present, self-propelled elevator systems utilize a power system that employs various power electronics to facilitate the power necessary to propel an elevator car in a hoistway. These power electronics include, for example, a power inverter (e.g., as switched variable speed alternating drive (AC) motor drive) to improve performance of the power system. A switched variable speed AC motor drive, for example, typically utilizes the switching of the semiconductor switches (e.g., transistors) to create the variable voltage and variable frequency output. However, the switching of power electronic devices in a power system can cause undesirable electromagnetic interference (EMI). In general, EMI noise can be categorized into two groups: differential mode (DM) noise and common-mode (CM) noise. DM noises are conducted between phases, while CM noises are conducted together with all phases through the parasitic capacitors to the ground. CM noises can cause additional concern in motor drive applications because CM noises increase the EMI in the motor drive, which can damage the motor bearing and winding insulation.

Various non-limiting embodiments described herein avoid the CM noise concerns by providing a self-propelled elevator system that implements a multi-phase linear induction machine, which includes one or more stators coupled to the elevator car. The stators operate in response to an electromagnetic field produced by an electrically conductive armature that is coupled to an inner area of the elevator system 10 such as, for example, a wall or facade of the hoistway. The electromagnetic field energizes the stators, thereby propelling (i.e., “self-propelling) the elevator car through the hoistway. Although the system is described as a three-phase system, it should be appreciated that the system can be implemented using different phases, such as, for example, two, four, five six, etc., without departing from the scope of the present disclosure. Accordingly, sound, noise, and/or vibration of the system is virtually zero because there is no mechanical contact between the moving parts as the elevator car (also referred to as the cabin) moves through the hoistway. In addition, each car included in the elevator system is self-propelled and energized, can travel autonomously inside the hoistway to service the customer calls requested at various floor following the software protocol installed in an elevator controller.

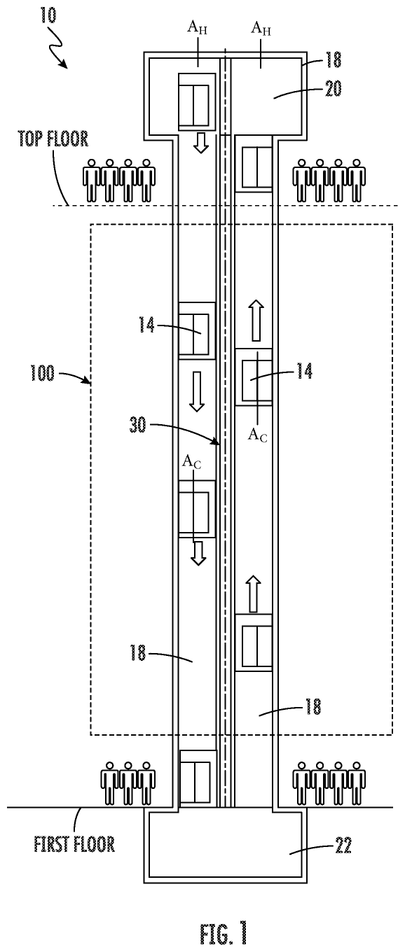

With reference now to FIG. 1, an elevator system 10 may be utilized in applications that require movement of a vehicle along a track. For example, the elevator system 10 may be utilized for elevators, trains, roller coasters, or the like. The elevator system 10 (sometimes referred to as a “linear propulsion system”) includes a three-phrase linear induction machine 100.

As shown in FIG. 1, the elevator system 10 comprises one or more hoistways 18. The hoistways 18 are disposed within a multi-story building and extend vertically along a center hoistway axis (A_{H}). The hoistway 18 is not limited to two hoistways 18. In some embodiments, the hoistways 18 may include a single hoistway 18 or more than two hoistways 18.

According to a non-limiting embodiment illustrated in FIG. 1, elevator cars 14 may travel upward in the first hoistway 18 and may travel downward in the second hoistway 18. It should be appreciated, however, that the elevator system 10 can be designed such that the elevators cars 14 travel both upwards and downwards in a common hoistway 18 without departing from the scope of the invention. In any case, the elevator cars 14 are configured travel in line with a center hoistway axis (A H). Although not shown in FIG. 1, elevator cars 14 may stop at intermediate floors to allow ingress to and egress from an elevator car 14.

According to the example illustrated in FIG. 1, the elevator system 10 can transport elevator cars 14 from a first floor to a top floor in the first hoistway 18 and can transport elevator cars 14 from the top floor to the first floor in the second hoistway 18. Above the top floor is an upper docking station 20 where elevator cars 14 can be docked or stowed. Likewise, below the first floor is a lower docking station 22 where elevator cars 14 can be docked or stowed. In one or more non-limiting embodiments, elevator cars 14 can be moved to the lower docking station for battery recharging as described in greater detail below. It should be appreciated that the upper docking station 20 may be located at the top floor, rather than above the top floor, and the lower docking station 22 may be located at the first floor, rather than below the first floor.

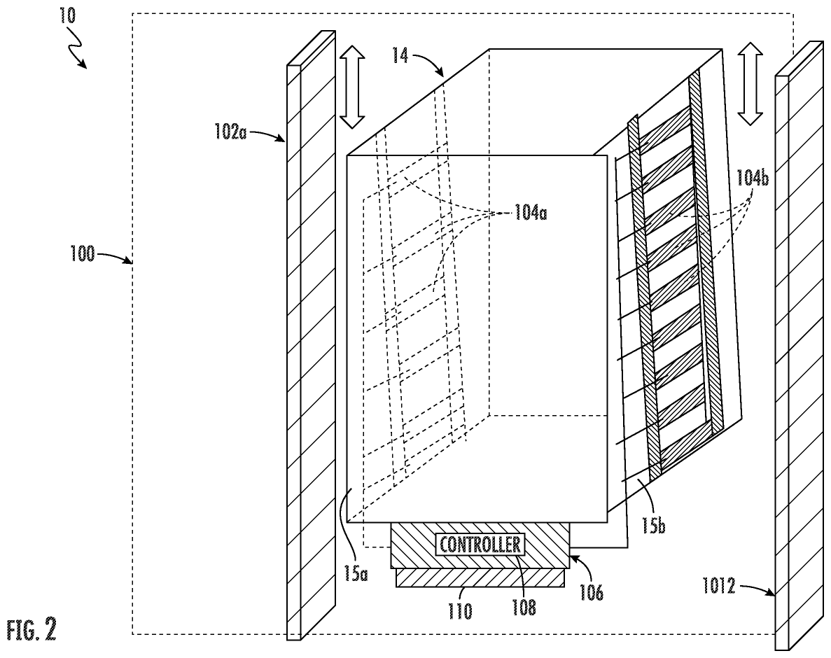

Turning now to FIG. 2, a three-phrase linear induction machine 100 is illustrated according to a non-limiting embodiment of the present disclosure. The three-phrase linear induction machine 100 includes one or more armatures 102 disposed in the hoistway 18 and one or more stators (collectively referred to as stators 104) coupled to an elevator car 14. In one or more non-limiting embodiments, a first armature 102a is disposed in the hoistway 18 and a second armature 102b disposed in the hoistway 18 opposite the first armature 102a. In one or more non-limiting embodiments, the first and second armatures 102a and 102b (assigned numeral 102 when referring to a single armature) are fixed to a location opposite the elevator car 14 such as, for example, a guide rail disposed in the hoistway 18, a first inner wall 19a or facade of the hoistway 18 included in the elevator system 10 and the second stationary armature 102b is coupled to the opposite inner wall 19b or facade of the hoistway 18.

The first and second armatures 102a and 102b are configured to electrically conduct electromagnetic energy. In one or more non-limiting embodiments, the first and second armatures 102a and 102b include a strip or beam, or in other embodiments can include several individual strips or beams, capable of conducting eddy currents therethrough. The electrically conductive material includes, for example, metal, a magnetic material, or a combination of both. The first and second armatures 102a and 102b extend vertically along the length of the hoistway 18.

The stators 104 are configured to generate a linear traveling electromagnetic field, which in turn generates a force capable of forcing the stators to move 104 upward or downward with respect to the first and second armatures 102a and 102b. As described herein, the electromagnetic field induces eddy currents that flow through the first and second armatures 102a and 102b, which in turn generate a magnetic force capable of moving the elevator car 14 through the hoistway 18.

In one or more non-limiting embodiments, the stators 104 include a first set of stators 104a fixed to a first side 15a of the elevator car 14 and adjacent the first armature 102a, and a second set of stators 104b fixed to a second side 15b of the elevator car 14 opposite the first side 15a of the elevator car 14 and adjacent the second armature 102b. The first set of stators 104a and the second set of stators 104b are electrically connected to power electronics 106. The power electronics 106 include a power inverter (not shown) in signal communication with and a controller 108. The controller 108 is configured to control the inverter and generate current that flows through the first and second set of stators 104a and 104b. In one or more non-limiting embodiments, each stator is in signal communication with its own dedicated sub-controller (not shown), and each sub-controller is in signal communication with the controller 108. Accordingly, the sub-controllers can drive current through a respective stator and the controller 108 can independently control each of the sub-controllers to control the current flow through a respective stator.

In one or more non-limiting embodiments, the elevator car 14 further includes a rechargeable battery 110 (e.g., a lithium-ion battery) in signal communication with the power electronics 106 (e.g., the power inverter) and the controller 108. Accordingly, the power electronics 106 can receive power from the rechargeable battery 110, and covert the battery power into electrical current that is delivered to the first and second set of stators 104a and 104b. As shown in FIG. 2, for example, the power electronics (e.g., the energy/power components including the battery, power electronics, controller, motors, etc.) can be installed on the elevator car 14 rather than located externally from the elevator car 14 (e.g., in a machine room) as in conventional elevator systems.

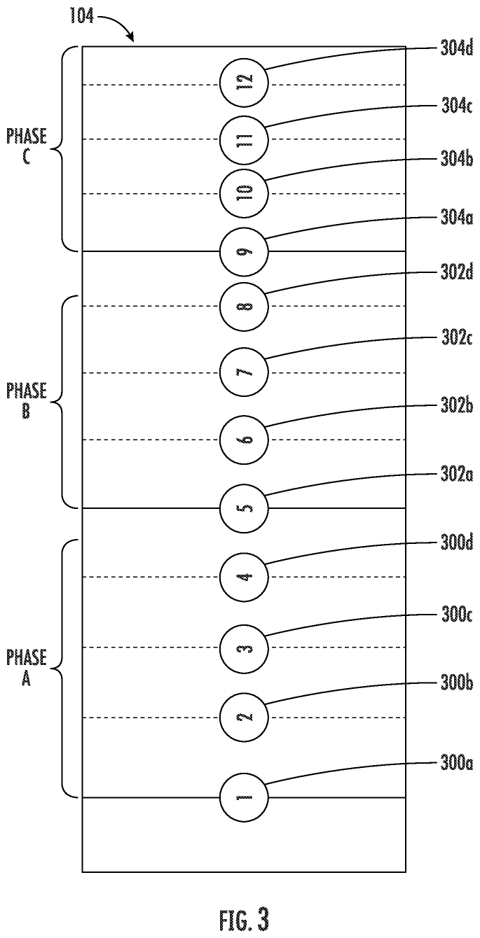

Referring to FIG. 3, a stator 104 is illustrated according to a non-limiting embodiment. The stator 104 includes a plurality of stator slots configured to receive a stator coil. In some embodiments, each stator coil corresponds to a respective phase and is disposed in a stator slot corresponding to the phase of the coil. In some embodiments the stator coils can be connected in series with one another, while in other embodiments the stator coils can connected in parallel with one another. The connection of the stator coils can be determined based on the application of elevator system 100. In one or more non-limiting embodiment, the stator 104 includes a first group of stator slots 300a-300d assigned to a first phase (e.g., phase A), a second group of stator slots 302a-302d assigned to a second phase (e.g., phase B), and a third group of stator slots 304a-304d assigned to a third phase (e.g., phase C). Accordingly, each group of stator slots (e.g., 300a-300d, 302a-302d, 304a-304d) generates a magnetic field having poles (e.g., north or south) that change position as the AC current oscillates through a complete cycle, thereby generating a linear traveling electromagnetic field. In one or more non-limiting embodiments, the phases of the AC current flowing through the coils of each respective group of stator slots (e.g., 300a-300d, 302a-302d, 304a-304d) are phase-shifted by 120 electric degrees. Accordingly, the magnetic polarity of the groups of stator slots (e.g., 300a-300d, 302a-302d, 304a-304d) are not all identical at the same instant of time. In one or more non-limiting embodiments, there is a direct match between the number of phases of the stator 104 and the power electronics 106. For example, when the power electronics 106 include a multi-phase (3, 4, 5, 6, etc. phases) inverter, the stators 104a and 104b can be designed to operate with a corresponding number of phases (e.g., 3, 4, 5, 6, etc. phases).

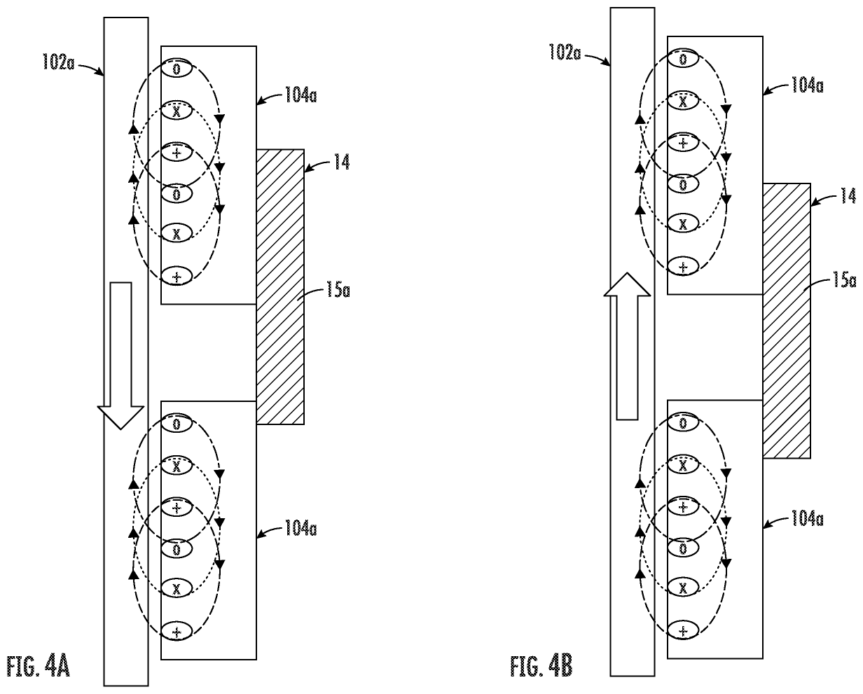

In one or more non-limiting embodiments, the controller 108 can selectively control the direction of the current flow through one or both of the first and second armatures 102a and 102b. In this manner, the controller 108 can generate current flow through the first and second set of stators 104a and 104b in a first direction (e.g., a downward direction) or in a second direction (e.g., an upward direction). Referring to FIG. 4A, for example, current flowing through the stators 104a in the first direction generates an electromagnetic filed having a flux that travels in a first direction. Accordingly, the magnetic flux traveling in the first direction induces a magnetic force that moves the elevator car 14 in a first direction (e.g., downward) through the hoistway 18. Referring to FIG. 4B, for example, current flowing through the first and second set of stators 104a in the second direction generates an electromagnetic field having a flux that travels in a second direction opposite the first direction. Accordingly, the magnetic flux traveling in the second direction induces a magnetic force that moves the elevator car 14 in a second direction (e.g., upward) through the hoistway 18. In one or more non-limiting embodiments, the arrangement of the stators 104a and 104b and their respective coils allows a corresponding elevator car 14 to magnetically levitate between the hoistway walls and move upward and/or downward therein, while also balancing and aligning the elevator car 14 along the center hoistway axis (A H).

In one or more non-limiting embodiments, the controller 108 can control first electrical current delivered to the first set of stators 104a independent from second electrical current delivered to the second set of stators 104b. In this manner, the controller 108 can independently adjust the level of the current delivered to the first and second stators 104a and 104b to control the balance of the elevator car 14. In one or more non-limiting embodiments, the controller 108 can monitor the load distribution applied to the elevator car 14, and actively control the level of current delivered to the first set of stators 104a and/or the second set of stators 104a based on the load distribution. For example, if a greater load or weight is present at the first side 15a of the elevator car 14 with respect to the second side 15b, a greater amount of current can be delivered to the first set of stators 104a compared to the second set of stators 104b so that a greater amount of magnetic force is applied to the right side 15a of the elevator car 14. In this manner, the elevator car 14 can be balanced using, for example, two stators 104a and/or 104b which can maintain a center car axis (A_{C}) of the elevator car 14 in line with the center hoistway axis (A_{H}). The controller 108 can further continuously monitor the load distribution and actively control the current delivered to the first and second set of stators 104a and 104b to maintain the balance of elevator car 14 while it travels through the hoistway 18. In addition, the elevator car 14 can maintain the center car axis (A_{C}) in line with the center hoistway axis (A_{H}) to prevent elevator car 14 from tilting inside of the hoistway 18 during a scenario where the elevator car 14 is loaded unevenly.

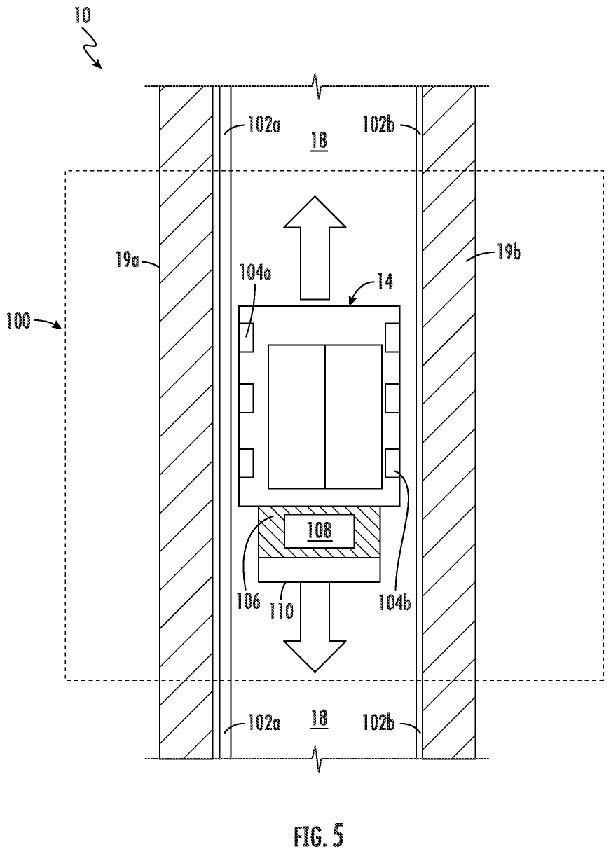

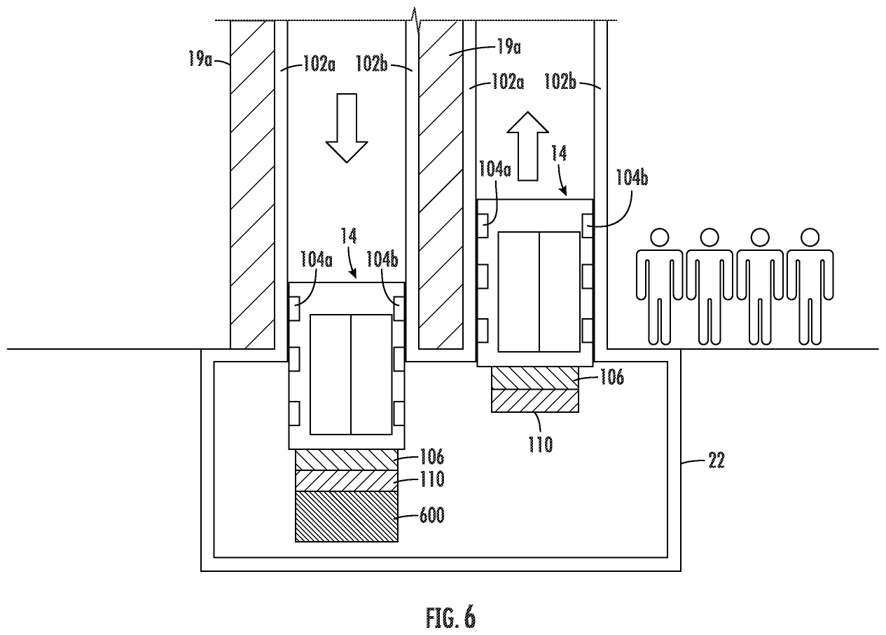

Turning now to FIGS. 5 and 6, a given elevator car 14 can selectively operate in a recharge mode, which can be invoked by the controller 108. In response to invoking the recharge mode, the elevator car 14 is moved (e.g., under the control of the controller 108) to the lower docking station 22 or the upper docking station 20 to recharge the battery 110. In one or more non-limiting embodiments, the controller 108 can monitor the remaining power of the battery 110 during normal operation of the elevator car 14. In response to the remaining battery power falling below a power threshold, the controller 108 can invoke the recharging mode and command the elevator car 14 to move to the lower docking station 22 or the upper docking station 20.

As shown in FIG. 6, for example, the lower docking station 22 includes a battery charger 600. When the recharge mode is invoked and the elevator car 14 is moved to the lower docking station 22, the rechargeable battery can be brought into close proximity, or physically connected, with the battery charger 600 to initiate battery recharging. In one or more non-limiting embodiments, the battery 110 can include a first connector and the battery charger 600 can include a second connector configured to mate with the first connector. In one or more non-limiting embodiments, the battery 110 can be recharged wirelessly positioned in close enough proximity to the charger 600. In either case, power from the charger 600 can be delivered to the battery 110 facilitate recharging. When the power of the battery 110 exceeds the power threshold or reaches full charge capacity (e.g., full available power), the controller 108 can invoke the normal operating mode of the elevator car 14. Accordingly, the elevator car 14 can be moved out of the docking station 22 and returned to service.

As described herein, various non-limiting embodiments of the present disclosure described herein provide a three-phrase induction machine included in an elevator system is provided and is capable of avoiding CM noise concerns by realizes in a tradition an elevator system that implements a three-phrase induction machine. The three-phrase induction machine includes one or more armatures and a plurality of stators. The armatures are disposed in a hoistway and configured to electrically conduct electromagnetic energy, and the plurality of stators fixed to an elevator car configured to travel through the hoistway. Each of the stators are configured to conduct electrical current therethrough and to generate an electromagnetic field in response to the current. The electromagnetic field induces eddy currents that flow through the at least armature to generate a magnetic force to move the elevator car through the hoistway.

The terminology used herein is for the purpose of describing particular embodiments only and is not intended to be limiting of the present disclosure. The terms “about” and “substantially” are intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A multi-phase linear induction machine included in an elevator system, the multi-phase induction machine comprising:
at least one armature disposed in a hoistway and configured to electrically conduct electromagnetic energy; and
a plurality of stators coupled to an elevator car configured to travel through the hoistway, each of the stators configured to conduct electrical current therethrough and to generate an electromagnetic field in response to the current,
wherein the electromagnetic field induces eddy currents that flow through the at least armature generate a magnetic force to move the elevator car through the hoistway.

2. The multi-phase induction machine of claim 1, wherein the at least one armature includes a first armature disposed in the hoistway and a second armature disposed in the hoistway opposite the first armature.

3. The multi-phase linear induction machine of claim 2, wherein the first and second armatures include an electrically conductive material configured to conduct the eddy currents therethrough.

4. The multi-phase induction machine of claim 3, wherein the first and second armatures extend vertically along a length of the hoistway.

5. The multi-phase induction machine of claim 4, wherein the plurality of stators includes a first set of stators coupled to a first side of the elevator car and adjacent the first armature, and a second set of stators coupled to a second side of the elevator car opposite the first side of the elevator car and adjacent the second armature.

6. The multi-phase induction machine of claim 5, wherein the first set of stators and the second set of stators are electrically connected to power electronics that are configured to deliver the electrical current to the first and second set of stators.

7. The multi-phase induction machine of claim 6, wherein the power electronics receive battery power from a rechargeable battery, and covert the battery power into the electrical current that is delivered to the first and second set of stators.

8. The multi-phase induction machine of claim 7, wherein a controller is configured to control the power electronics and selectively control the direction of the current flow through the first and second armatures.

9. The multi-phase induction machine of claim 8, wherein current flowing through the first and second set of stators in a first direction generates an electromagnetic filed having a flux that travels in a first direction, and current flowing through the first and second set of stators in a second direction generates an electromagnetic field having a flux that travels in a second direction opposite the first direction.

10. The multi-phase induction machine of claim 9, wherein the flux traveling in the first direction produces a first magnetic force that moves the elevator car through the hoistway in a first vertical direction, and wherein the flux traveling in the second direction produces a second magnetic force that moves the elevator car through the hoistway in a second vertical direction opposite the first vertical direction.

11. The multi-phase induction machine of claim 8, wherein the controller invokes a recharge mode and in response to invoking the recharge mode moves the elevator car 14 to a docking station included in the hoist to recharge the battery.

12. The multi-phase induction machine of claim 11, wherein the docking station includes a battery charger, and wherein moving the elevator car to the docking station establishes electrical transfer between the rechargeable battery and the battery charger to recharge the battery.

13. The multi-phase induction linear induction machine of claim 1, wherein the at least one armature and the plurality of stators establish a three-phase machine.

14. The multi-phase induction linear induction machine of claim 13, wherein each of the first and second set of stators includes two or more stators.

15. The multi-phase induction linear induction machine of claim 13, wherein the two or more stators are configured to maintain a center car axis of the elevator car in line with a center hoistway axis of the hoistway.

16. A method of controlling a multi-phase linear induction machine included in an elevator system, the method comprising:
disposing at least one armature in a hoistway to electrically conduct electromagnetic energy;
coupling a plurality of stators to an elevator car configured to travel through the hoistway;
conducting electrical current through the plurality of stators to generate an electromagnetic field; and
inducing a flow of eddy currents through the at least armature in response to generating the electromagnetic field to generate a magnetic force that moves the elevator car through the hoistway.

17. The method of claim 16, wherein the at least one armature includes a first armature disposed in the hoistway and a second armature disposed in the hoistway opposite the first armature.

18. The method of claim 17, wherein the first and second armatures include an electrically conductive material configured to conduct the eddy currents therethrough.

19. The method of claim 18, wherein the first and second armatures extend vertically along a length of the hoistway.

20. The method of claim 19, wherein plurality of stators includes a first set of stators coupled to a first side of the elevator car and adjacent the first armature, and a second set of stators coupled to a second side of the elevator car opposite the first side of the elevator car and adjacent the second armature.
